(19) United States
(12) Patent Application Publication
(10) Pub. No.: US 2011/0186780 A1
(43) Pub. Date: Aug. 4, 2011

(54) Transition Metal Ion Doped Semiconductor Nanocrystals and a Process for the Preparation Thereof

(75) Inventors: Narayan Pradhan, Kolkata (IN); Nikhil Ranjan Jana, Kolkata (IN); Dipankar Das Sarma, Kolkata (IN)

(73) Assignee: INDIAN ASSOCIATION FOR THE CULTIVATION OF SCIENCE, Kolkata (IN)

(21) Appl. No.: 13/061,441

(22) PCT Filed: Aug. 17, 2009
(86) PCT No.: PCT/IN2009/000455

§ 371 Date: Apr. 19, 2011

(30) Foreign Application Priority Data
Aug. 28, 2008 (IN) 1473/KOL/2008

(51) Int. Cl. C09K 11/88; C09K 11/08; C09K 11/56; B82B 1/00; B82Y 20/00; B82Y 40/00

(52) U.S. Cl. 252/301.6 S; 252/301.4 R; 252/301.6 R; 977/774; 977/950; 257/E33.005

(57) ABSTRACT

The present invention deals with transition metal ions doped semiconductor nanocrystals that are free from heavy metals like cadmium and therefore environment friendly and useful for biological applications. The present invention also describes a process for the preparation of such transition metal ion doped semiconductor nanocrystals, where the reactions take place at a temperature less than 3000 C. The said doped nanocrystals are stable in air and under UV radiation in both solution and precipitated solid form.

### FIELD OF THE INVENTION

The present invention relates to transition metal ion doped semiconductor nanocrystals and a process for the preparation thereof. The present invention more particularly relates to free-flowing, transition metal ions doped semiconductor nanocrystals comprising dopants and host nanocrystals.

More preferably, the present invention relates to free-flowing, transition metal ions doped semiconductor nanocrystals comprising dopant ions selected from the group consisting of Mn, Ni, Cu and host nanocrystals selected from the group consisting of ZnS, ZnSe and ZnTe.

The free-flowing transition metal ions doped semiconductor nanocrystals of the present invention have wide applications, including but not limiting to the preparation of light emitting diode, solar cell and bioimaging applications.

### BACKGROUND AND PRIOR ART OF THE INVENTION

Fluorescing semiconductor nanomaterials e.g. CdSe are commonly known as quantum dots and are proven as stable bio-label agents for biological imaging rather than traditionally or conventionally used organic dyes (Abhijit Mandal, Junichi Nakayama, Naoto Tamai, Vasudevanpillai Biju, and Mitsuru Isikawa J. Phys. Chem. B, 2007, 111 (44)). These quantum dots when shelled with higher band gap materials e.g. ZnS to make CdSe—ZnS core shell, they achieve much higher emission intensities (Dabbousi, R. O.; Rodriguez-Viejo, J; Mikulec, F. V.; Heine, J. R; Mattoussi, H; Ober, R; Jensen, K. F; Bawendi, M. G. J. Phys. Chem. B, 1997, 101, 9463) and the said quantum dots do not photo-bleach easily when used for bio-imaging. In spite of their improved properties, these materials are not readily and widely accepted by the biological community because of the adverse toxicity of cadmium. Therefore, it has been the endeavor of the scientists for a long time to prepare an alternative form of nanocrystals with acceptable quantum yield (>10%) having stable emission property but without any toxic material so that it would be acceptable for all practical purposes as well as routine applications.

It was found that one of the alternative forms of the doped semiconductor nanocrystals is the transition metal doped semiconductors. It was also known that doped nanocrystals could emit different colors in the visible window (Pradhan N et al., J. Am. Chem. Soc., 2005, 127 (50), pp 17586-17587). This paper also reports Mn doped ZnSe nanocrystals with about 50% quantum yield, but the task of generating stable and acceptable intensity emission nanocrystals and method of making them continued to remain a real challenge for the scientists for a considerable period of time, this material achieved still remains unacceptable since it contains selenium as a partially toxic material. The method needs access to tributylphosphine which is toxic and pyrophoric chemical and needs high skilled workers to handle it and to achieve the required quality.

Another reference may be made to International patent publication no. WO2006116337, which discloses transition metal ion doped semiconductor nanocrystals comprising metal dopants selected from the group I, II, III, IV and transitional metals. This patent reports increased photoluminescence and stability for applications such as biological labeling, light emitting diode and solar cell. The main drawback of this synthesis process is that the raw materials include toxic phosphine chemicals.

Still another reference may be made to U.S. Pat. No. 6,780,242, disclosing method for producing high quality semiconductor nanocrystal doped with manganese. This method comprises: (a) a process where a manganese organometallic precursor is mixed with a group II organometallic precursor and a group VI organometallic precursor to supply a mixture of precursors; (b) a process where the mixture of precursors is diluted with a dilution solvent to supply a injection mixture; (c) a process where a coordination solvent is heated; (d) a process where the heated coordination solvent is stirred; and (e) a process where the injection mixture is injected into the heated coordination solvent being stirred. This method is useful especially for producing a high quality zinc selenide (ZnSe) nanocrystal doped with manganese, a high quality zinc sulfide (ZnS) nanocrystal doped with manganese and a high quality zinc telluride (ZnTe) nanocrystal doped with manganese. However, the process includes use of organometallic precursors, which are toxic and explosive. The quantum yield was at best 22% at room temperature, further the dopant emission is accompanied by substantial host emissions, the achieved doped nanocrystals are not reported to be nontoxic and neither these are free flowing.

Yet another reference may be made to U.S. Pat. No. 5,882,779 that disclose a class of high efficiency (i.e., greater than 20%) materials for use as display pixels to replace conventional phosphors in television, monitor, and flat panel displays. The materials are comprised of nanocrystals such as CdSₓSe₁₋ₓ, CuCl, GaN, CdTeₓS₁₋ₓ, ZnTe, ZnSe, ZnS, or porous Si or Ge alloys which may or may not contain a luminescent center. The nanocrystals may be doped with a luminescent center such as Mn²⁺ or another transition metal. These nanocrystal surfaces were passivated to provide high quantum efficiency. The nanocrystals have all dimensions comparable to the exciton radius (e.g., a size in the range of approximately 1 nm to approximately 10 nm). This selection of size of the nanocrystals is critical in displaying phosphorescence that implies a shift in the emission wavelength of a constituent semiconductor material with respect to a characteristic wavelength observed in the bulk. A field effect flat panel display is described that employs the nanocrystals of this invention, as are embodiments of plasma displays and fluorescent light sources. However this patent only discloses the application as display and light sources only and not directed towards toxicity assessment for biological application, further the nanocrystals comprise cadmium, thus toxic and the quantum yield is reported to be only up to 20%, therefore this citation teaches away from the present invention, which discloses nontoxic freely flowing nanocrystals also suitable for biological applications.

Still another reference may be made to Nano Res. (2008) 1: 138 144 that disclose Mn doped ZnSe, which are free from heavy metals, specifically Cd and has been reported for increased photoluminescence. However, the process steps completely teach away from the present invention. The article further mentions that the shape of the nanocrystals can be controlled to increase the photoluminescence of the doped nanocrystals. The synthesis method is quite complicated and requires highly skilled workers to execute. The article reports Mn doped ZnSe nanocrystals with different shapes. The main drawback of this study is the use of Tributylphosphine which is pyrophoric and therefore being unsuitable for different cell imaging applications. This synthesis method is not environmental friendly as tributylphosphine in excess is needed which is a pyrophoric chemical. The product obtained by this method is neither non-sticky nor cost effective.

Yet another reference may be made to an article from Adv. Funct. Mater. 2007, 17, 1654-1662 that reports that high Photoluminescence (PL) is achieved at annealing temperature up to 300° C. This method also uses the shelling technique. The said composite, however, contains Cadmium, which is a toxic metal. Further the nanocrystals formed are sticky and not suitable for biological applications.

Highly fluorescent non toxic materials as mentioned in the above citations, are found to be technologically important, not only for biological applications, but also in several other applications, such as for lighting and display devices. But in all such cases, presence of Cd, absence of sufficient quantum efficiencies and processability are considered to be real hindrances to a widespread applicability of such materials. The inventors of the present invention understood the urgent need of a transition metal ion doped semiconductor nanocrystals that obviates the drawbacks of the existing prior art.

### OBJECTS OF THE INVENTION

The main object of the present invention is to provide a free-flowing, transition metal ions doped semiconductor nanocrystals.

Another object of the present invention is to provide free-flowing, transition metal ions doped semiconductor nanocrystals of high quantum yield in excess of 20% in both aqueous and non-aqueous media.

A further objective of the present invention is to provide free-flowing transition metal ions doped semiconductor nanocrystals that are stable in air and under UV radiation both in solution and in the precipitated solid form.

A still another objective of the present invention is to provide a process for the preparation of the said free-flowing, transition metal ions doped semiconductor nanocrystals.

### SUMMARY OF THE INVENTION

The present invention provides free-flowing, transition metal ions doped semiconductor nanocrystals having high quantum yield in excess of 20% and are useful for display, lighting, solar cells and biological applications due to its non-toxicity and long term stability.

The present invention further provides a process for the preparation of the transition metal ion doped semiconductor nanocrystals. The said nanocrystals are characterized by
i. in excess of 20% photoluminescence quantum yield;
ii. long term stability for a period of 6-12 months;
iii. non-sticky and free flowing;
iv. particle size in the range of 1-10 nm;
v. non-toxic and non-pyrophoric.

Accordingly, the present invention provides free-flowing, transition metal ions doped semiconductor nanocrystals.

In one embodiment of the present invention, the said transition metal ions doped semiconductor nanocrystals are in excess of 20 quantum yield at both in aqueous and non-aqueous medium.

In another embodiment of the present invention, the said transition metal ions doped semiconductor nanocrystals are stable for a period of at least up to 6 months in air and at least 24 hours under UV radiation both in solution and in the precipitated solid form.

In still another embodiment of the present invention, the said transition metal ions doped semiconductor nanocrystals are in the form of free flowing powder and non sticky.

In still further embodiment of the present invention, the said nanocrystals can also exist in solution form.

In yet another embodiment of the present invention, the said transition metal ions doped semiconductor nanocrystals which are free from cadmium and are non-toxic, therefore biologically acceptable and eco-friendly.

In yet still another embodiment of the present invention, the said transition metal ions doped semiconductor nanocrystals show desirable emission property and remain stable.

Further in another embodiment of the present invention, the process for the preparation of transition metal ions doped semiconductor nanocrystals, comprises the following steps:
(a) preparing oxides of dopants;
(b) synthesizing host materials in a predetermined size required for doping;
(c) introducing dopant oxides as obtained from step (a) to the solution of host materials as obtained from step (b) for inserting dopant ions into the host nanocrystals; and
(d) coating the doped nanocrystals as obtained from step (c) followed by further over-shelling to get intense dopant emission;

In one more embodiment of the present invention, the preparation of the transition metal ion doped semiconductor nanocrystals takes place at a temperature in the range of 180° C. to 300° C. under normal atmospheric conditions.

### BRIEF DESCRIPTION OF THE DRAWINGS

The present invention is described herein below with reference to the accompanying drawings, wherein—

FIG. 1 illustrates spectral and digital views of different doped nanocrystals in solution.

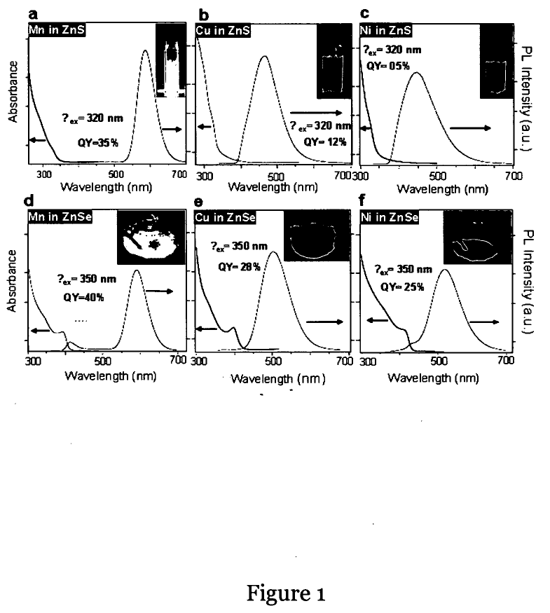

FIGS. 1a-c illustrate the typical UV-visible and photoluminescence (PL) spectra of Mn, Cu and Ni doped ZnS respectively in chloroform. Digital pictures presented in the inserts are taken after irradiation under hand held UV-lamp at 254 nm.

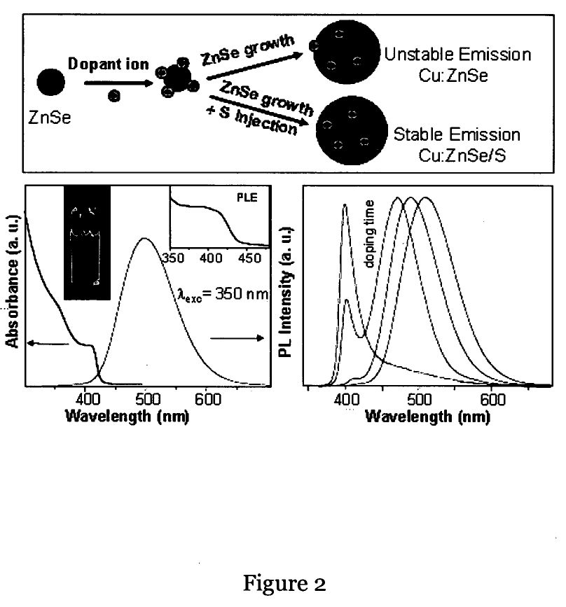

FIGS. 1d-f illustrate UV-visible and PL spectra of Mn, Cu and Ni doped ZnSe respectively and inserts are the digital pictures of the reaction flasks. For doped zinc sulfide nanocrystals the PL measurements were taken using 320 nm excitation wavelength; PL measurements of the doped zinc selenide nanoparticles were taken using 350 nm excitation wavelength. In each panel, the typical PL quantum yield obtained is indicated.

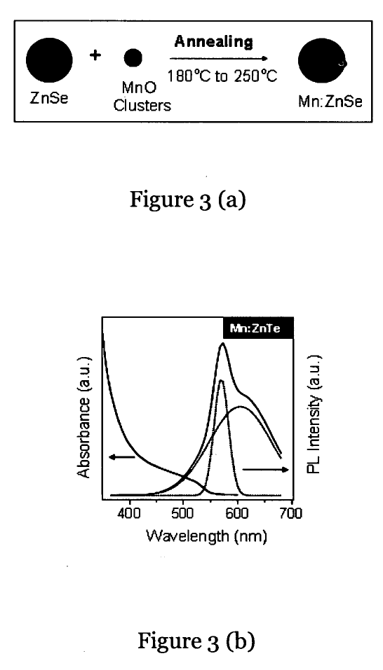

FIG. 2 illustrates:
(a) Upper Panel: Schematic presentation of synthesis of Cu:ZnSe/S;
(b) Bottom Panel (left): UV-visible and PL spectra of typical Cu doped ZnSe/S and
(c) Bottom panel (right) PL spectra of undoped ZnSe and size tunable Cu doped ZnSe nanocrystals. Injection of S in each stage stabilizes the emission intensity.

FIG. 3 illustrates:
(a) Schematic diagram for Mn doped ZnS/ZnSe
(b) Absorption and emission spectra of Mn doped ZnTe, in which the dotted lines denote deconvoluted spectra.

Table 1 demonstrates the quantum yield of the transition metal ion doped semiconductor nanocrystals at both aqueous and non-aqueous mediums.

Table 2 demonstrates the workable range of the duration of stability of the said nanocrystals in different liquid and precipitated solid state for both in air and UV.

### DETAILED DESCRIPTION OF THE INVENTION

The known transition metal ion doped semiconductor nanocrystals are obtained in a quantum yield which is less than 5% in solution and 18% in solid form (Ullah, M. H. & Ha, C. S. Size-Controlled Synthesis and Optical properties of Doped Nanoparticles Prepared by Soft Solution Processing. J. Nanosc. Nanotech. 5, 1376-1394 (2005), Bhargava, R. N., Gallagher, D., Hong, X. & Nurmikko. A, Optical properties of manganese-doped nanocrystals of zinc sulfide (Phys. Rev. Lett. 72, 416-19 (1994)) having the quantum yield of the nanocrystals of the present invention in both aqueous and non-aqueous mediums.

In one embodiment of the present invention, the nanocrystals of the present invention comprising Mn—ZnS have the brightest doping ever reported in the literature showing yellow orange emission of about 580 nm on radiation at 256 nm.

The generic steps of preparing the transition metal ion doped semiconductor nanocrystals are as following:
i. Synthesis of host nanoparticles
ii. Dopant addition
iii. Further shelling of host nanocrystals

The purified transition metal ion doped semiconductor nanocrystals of the present invention are free flowing powder and are not sticky.

The host nanocrystals as synthesized by known method, are purified with organic solvents (Pradhan, N., Battaglia, D. M., Liu, Y. & Peng, X. Efficient, Stable, Small, and Water-Soluble Doped ZnSe Nanocrystal Emitters as Non-Cadmium Biomedical Labels. Nano Lett. 7, 312-317 (2007) such as octadecene, thus becoming oily because of difficulty in removing and drying the long chain high boiling solvents from the nanocrystals.

According to the present invention, the process for the preparation of transition metal ion doped semiconductor nanocrystals, comprises the following steps:
(a) preparing oxides of dopants, by a known method;
(b) synthesizing host materials in a known manner in a predetermined size required for doping;
(c) introducing dopant oxides as obtained from step (a) to the solution of host materials as obtained from step (b) for inserting dopant ions into the host nanocrystals; and
(d) coating the doped nanocrystals as obtained from step (c) followed by further over-shelling to get intense dopant emission.

In the process of the present invention, the reaction of dopant oxide and host nanocrystals takes place at a temperature in the range of 180° C. to 300° C. under ordinary atmospheric conditions.

In one embodiment of the present invention, the Mn doped ZnS nanocrystals show yellow-orange emission (˜580 nm) on UV radiation at 250-330 nm.

In yet another embodiment of the present invention, the quantum yield of the nanocrystals prepared by the above mentioned method is in excess of 20% both in aqueous and non-aqueous solution as compared to best reported quantum yield of less than 5% in solution and 18% in solid form.

In still another embodiment of the present invention, the nontoxic, free-flowing nanocrystals that are synthesized according to the process of the present invention is selected from the group comprising Mn/Cu/Ni doped ZnS/ZnSe/ZnTe semiconductor nanocrystals.

In yet another embodiment of the present invention, the Ni is doped on host ZnSe emits green colour.

In still another embodiment of the present invention, when Cu is doped on ZnS, the doped particles emit blue color and Cu doped on ZnSe emits green florescence.

Further in another embodiment of the present invention, the said method of the present invention is generic and it works for preparing combination of different dopant oxides (Mn, Ni and Cu) with different host semiconductor materials (Zn S, ZnSe and ZnTe).

In yet another aspect of the present invention, the transition metal ion doped semiconductor nanocrystals are free from toxic Cd, thus is useful as a safe tagging agent in different biological applications.

In still another aspect of the present invention, the transition metal ion doped semiconductor nanocrystals are stable both in air and UV radiation and useful as photo-stable materials suitable for using in vitro and in vivo biological systems.

In further another aspect of the present invention, it is found that high quantum yield (20-40%) in water makes the nanocrystals of the present invention as superior to all existing nanocrystals designed for these purposes, except for Mn doped ZnSe.

In another feature of the present invention, the diameters of the said doped nanocrystals are in the range of 1 nm to 10 nm.

In yet another feature of the present invention, the nanocrystals are having diameters more preferably in the range of 2.5-5.5 nm.

In still another feature of the present invention, the doped nanocrystals do not have re-absorption property, which indicates that for these nanocrystals, their absorption and emission bands do not overlap. Hence, these materials are better applicable where a large quantity of materials is needed, for example in making a device for light emitting system.

Further in another aspect of the present invention, the process for the preparation of the transition metal ion doped semiconductor nanocrystals is represented by the following flow diagram.

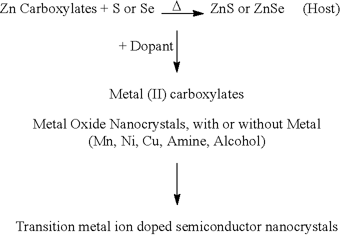

The following examples are given by the way of representation of the present invention and therefore should not be construed to limit the scope thereof. The other modifications and alternatives of this invention which are intended to be covered within the ambit thereof are within the knowledge of a person having the average skill in the art.

### Example 1

### Process for the Preparation of Transition Metal Ion Doped Semiconductor Nanocrystals

Transition metal oxide stock solutions were prepared by taking 0.5 mmol of their respective acetates in 5 ml of oleylamine. The mixture was degassed and heated to get a clear solution. For Mn doped zinc sulfide nanocrystals first the host ZnS nanocrystals were synthesized and MnO solutions were injected during growth stage. For ZnS nanocrystals synthesis, 0.1 mmol of Zinc Stearate, Zn(St)₂ and 10 ml of ODE are loaded in a 50 ml three necked flask, degassed for 10 minutes at 100° C. by purging with argon and then heated to 300° C. In a vial, 0.5 mmol S powder in 1 ml of ODE was taken with 0.3 g of ODA under argon and mixture was injected into the above reaction flask at 300° C. The temperature was reduced to 250° C. and 1 ml of MnO stock solution was injected. Then the reaction temperature was again increased to 280° C. for ZnS growth. 1.0 mmol Zn(St)₂ with 0.5 mmol SA in 5 ml of ODE was injected into it. The mixture was annealed at 250° C. for 10 min and cooled to room temperature. In case of copper doped ZnS, after the sulfur injection the reaction flask was cooled to 180° C. and 1 ml of CuO solution oleylamine was added drop wise into it. For nickel doping in ZnS, the flask was cooled 210° C. after sulfur injection and 1 ml of NiO solution in oleylamine was drop wise added to it to avoid nickel sulfide formation. Then 1.0 mmol zinc undecylenate and 1 mmol undecylenic acid dissolved in 4 ml ODE were phase wise injected to the above solution at 240° C. The mixture was annealed at that temperature for 60 min.

### Example 2

### Process for the Estimation of Quantum Yield of the Transition Metal Ion Doped Semiconductor Nanocrystals at Aqueous and Non-Aqueous Medium

The QY of the nanocrystals were determined with respect to an organic dye named as Quinine sulphate.
i. First absorption and emission of quinine sulphate was measured. The emission measurement was done at the excitation wavelength same to the doped nanocrystals.
ii. Same procedure was applied for D-dots.

The emission area of both dye and d-dots were calculated. These emission areas were divided by their optical density (OD) value. The QY was calculated using a known formula. Quantum yield was increased by optimizing the reaction condition.

TABLE 1

| Doped | | | Colour of |
|---|---|---|---|
| Materials | Reported QY | Achieved QY | Emission |
| Mn:ZnS | 18% | 36% | Yellow- |
| | [J. Lumin., 60-61, 1994, | | orange |
| | 275-280] | | |
| Ni:ZnS | Not reported | 5% | Green |
| Cu:ZnS | Not reported | 9% | Blue-green |
| Mn:ZnSe | ~50% | 30% | Yellow- |
| | [Nano Lett., 2007, 7 (2), | | orange |
| | 312-317] | | |
| Ni:ZnSe | Not reported | 25% | Green |
| Cu:ZnSe | 40% (unstable) | 40% | Blue-green |
| | | (Stable) | |
| Mn:ZnTe | Not reported | 6% | Yellow- |
| | | | orange |
| Ni:ZnTe | Not reported | 2% | Green |
| Cu:ZnTe | Not reported | 3% | Blue-green |

### Example 3

### Process for Estimating the Stability of the Transition Metal Ion Doped Semiconductor Nanocrystals in Air and Under UV Radiation in Solution and in the Precipitated Solid Form

The stability was checked by keeping the powders open to air. For the UV irradiation experiments, the nanocrystal solution taken in chloroform and continuously irradiate with UV lamp. Doping emission is found stable in presence of calculated amount of Sulfur injection in the reaction mixture with enhanced intensity.

TABLE 2

| | | | Temp. stability | Temp Stability | | |
|---|---|---|---|---|---|---|
| | Emission peak | Water | in 1-Octadecene | in water | pH | Time |
| Compound | (nm) and QY | solubility | (at 300° C.) | (100° C.) | stability | stability |
| Mn—ZnS | ~586 nm, | Yes | Yes | Yes | Yes stable | At least up |
| | Max QY = 40% | | | | from pH = | to 6 Months |
| | Stable Average | | | | 5-9 | |
| | 30-36% | | | | | |
| Ni—ZnS | ~450-460 | — | Yes | — | — | 10 Days and |
| | QY = 05% | | | | | then decreases |
| Cu—ZnS | ~450-480 | Yes | Yes | Yes | — | At least up |
| | QY = 09% | | | | | to One Month |
| Mn—ZnSe | ~580 | Yes | Yes | Yes | pH-6-8 | At least up |
| | Max QY = 40% | | | | | to 6 months |
| | Stable Average | | | | | |
| | 25-30% | | | | | |
| Ni—ZnSe | ~490-530 nm | — | Yes | — | — | 3 months |
| | QY = 25% under | | | | | (Under Argon) |
| | inert atmosphere | | | | | |
| Cu—ZnSe* | ~490-530 nm | — | Yes | — | No | Not stable in |
| | QY = 28% under | | | | | air but stable |
| | nitrogen | | | | | under Argon |
| Mn—ZnTe | ~580 nm | — | Yes | — | No | Stable for qt |
| | | | | | | least up to |
| | | | | | | 2-10 hours |
| Ni—ZnTe | ~620-630 nm | — | — | — | — | (Not |
| | (Not Reproducible) | | | | | optimized) |
| Cu—ZnTe | ~620-630 nm | — | — | — | — | (Not |
| | (Not Reproducible) | | | | | optimized) |
| CdSe | 90% | No (Using | Max 150° C. | | Unstable | Stable for |
| | | MPA) | | | | years under |
| | | | | | | Argon |
| CdSe/ZnS | (Ref NN- | Yes | 250° C. | Yes | pH = 8.0 | At least up |
| | Labs) >40% | | | | | to one year |

### Example 4

### Process for Preparing Free Flowing Powders of the Transition Metal Ion Doped Semiconductor Nanocrystals

The reaction mixture contains doped nanocrystals, unreacted small metal oxide crystals, free amines and unreacted precursors. After precipitation with acetone nanocrystals and unreacted precursor of zinc are expected to precipitate. Small nanocrystals of MnO and the solution of S or Se which is in liquid form should be washed away with the liquid solution. Nanocrystals along with zinc precursors (other than zinc oleate which are washed away with acetone) are dissolved in hexane on gentle heating. Then the reaction mixture was allowed to cool naturally to room temperature where all of the zinc precursors precipitate from the hexane solution. The upper liquid solution of doped nanocrystals was removed and further precipitated with few micro drops of methanol following size selective procedure to remove any trace of small MnO present with the nanocrystals. The precipitated nanocrystals dissolved in chloroform. Then the chloroform was evaporated to get powders.

### Example 5

### Determination of Emission Properties of the Transition Metal Ion Doped Semiconductor Nanocrystals

The purified nanocrystals were dissolved in chloroform and their optical properties are determined by photoluminescence (PL) and UV-Vis measurements. For PL measurements the excitation wavelength are 320 nm and 350 nm for Zn S and ZnSe hosts respectively.

### Example 6

### Water Solubility of the Transition Metal Ion Doped Semiconductor Nanocrystals

Water soluble doped nanocrystals are prepared by Ligand exchange using mercaptopropionic acid (MPA)—The Mn:ZnS nanocrystals were purified and dissolved in chloroform. MPA was added drop wise to this solution until the solution becomes cloudy. This mixture was then centrifuged to precipitate MPA capped nanocrystals and the precipitated particles were washed with chloroform to remove excess MPA. Then to the precipitate water was added and NaHCO₃ was added to it to make a clear solution.

### Example 7

### Stability of the Cu Doped ZnS/ZnSe Nanocrystals

The stable green emission with above 40% QY both in organic as well as in aqueous solution is achieved by putting a very thin hetero-layer of ZnS/Se on the transition metal ion doped ZnSe nanocrystals. Presence of 10% S on the shell growth completely changes the stability. The stability of Cu doped ZnSe nanocrystals is increased by injection of additional calculated amount of sulfur solution into the reaction mixture. The green emission from Cu:ZnSe/S is stable both in organic as well as in aqueous solution having the QY ˜40%.

The same method is also extended to Mn doped ZnSe injection of appropriate amount of S to Mn doped ZnSe or even better to start with small size host ZnS nucleation and growth with MnSe and ZnSe leads to ultra stable emissions which are found better than pure Mn doped ZnSe emission.

### ADVANTAGES OF THE INVENTION

The main advantages of the present invention are:
1. The transition metal in doped semiconductor nanocrystals are non-toxic and environment friendly and therefore, is suitable for biological applications.
2. The reaction is a single pot reaction, therefore easy to perform.
3. The obtained doped nanocrystals have high stability and photoluminescence efficiency such that used for the preparation of light emitting diode.
4. The obtained doped nanocrystals are useful as components of solar cells.
5. The doped nanocrystals are non-sticky and capable of freely flowing making it easier to process them.
6. The method for obtaining the nanocrystals is an easy synthetic method and cost effective.

What is claimed is:

1. Transition metal ion doped semiconductor nanocrystals comprising dopant ions and host nanocrystals free from cadmium.

2. Transition metal ion doped semiconductor nanocrystals as claimed in claim 1, wherein said doped nanocrystals have photoluminescence efficiency in the range of from 20% to 40%.

3. Transition metal ion doped semiconductor nanocrystals as claimed in claim 1, wherein the said doped nanocrystals are stable for up to 12 months in air and up to 240 hours under ultraviolet radiation both in solution and in precipitated solid form.

4. Transition metal ion doped semiconductor nanocrystals as claimed in claim 1, wherein the said nanocrystals are being in the form of free-flowing powder or solution.

5. Transition metal ion doped semiconductor nanocrystals as claimed in claim 1, wherein the said doped nanocrystals have diameters in the range of from 2.5 nm to 5.5 nm.

6. Transition metal ion doped semiconductor nanocrystals as claimed in claim 1, wherein said dopant ion is selected from the group comprising Mn, Ni and Cu.

7. Transition metal ion doped semiconductor nanocrystals as claimed in claim 1, wherein the host nanocrystal is preferably selected from the group comprising ZnS, ZnSe and ZnTe.

8. Transition metal ion doped semiconductor nanocrystals as claimed in claims 2 and 3, wherein the Mn:ZnS nanocrystals retain about 40% photoluminescence efficiency for at least up to 6 months.

9. Transition metal ion doped semiconductor nanocrystals as claimed in claims 2 and 3, wherein the Cu:ZnSe nanocrystals remain stable at least up to one year retaining its about 40% photoluminescence efficiency.

10. Transition metal ion doped semiconductor nanocrystals as claimed in claim 8, wherein said Cu:ZnSe nanocrystals further comprise 0.1-10% of sulphur for increasing the stability.

11. Transition metal ion doped semiconductor nanocrystals as claimed in claims 2 and 3, wherein the Cu:ZnS nanocrystals remain stable at least up to 1 year retaining its 20-30% photoluminescence efficiency.

12. Transition metal ion doped semiconductor nanocrystals as claimed in claim 3, wherein the Cu:ZnS nanocrystals further comprise 0.1-10% of selenium for increasing the stability.

13. Transition metal ion doped semiconductor nanocrystals as claimed in claim 1, wherein the said doped nanocrystals show emission at the range of about 250 nm to about 580 nm.

14. A process for the preparation of transition metal ion doped semiconductor nanocrystals, wherein the said process comprising the following steps of:
a. preparing oxides of dopants or fluorescence quenchers by a known method;
b. synthesizing host nanocrystals in a predetermined size required for doping by a known method;
c. inserting the dopant oxides as obtained from step (a) to the solution of host nanocrystals to obtain doped nanocrystals; and
d. over-shelling the doped nanocrystals as obtained from step (c) to get intense dopant emission.

15. A process as claimed in claim 13, wherein said process of insertion of the dopants into the host nanocrystals followed by over-shelling being performed at a temperature ranging between 180 to 300 degree Celsius under normal atmospheric conditions.
